(19) United States
(12) Patent Application Publication
(10) Pub. No.: US 2007/0264533 A1
(43) Pub. Date: Nov. 15, 2007

(54) Information recording medium glass substrate and information recording medium

(75) Inventors: Kouichi Tsuda, Nagano (JP); Ryoji Kobayashi, Nagano (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd, Tokyo (JP)

(21) Appl. No.: 11/798,494

(22) Filed: May 14, 2007

(30) Foreign Application Priority Data
May 15, 2006 (JP) JP PA 2006-135573
Mar. 9, 2007 (JP) JP PA 2007-060533

(51) Int. Cl. C03C 3/066

(52) U.S. Cl. 428/846.9; 501/79

(57) ABSTRACT

Information recording medium glass substrate which is a molded article composed of an alkali metal-containing glass material having a composition including at least B, Al, alkali metals, Zn, and Si, and satisfying certain relational equations in molar proportions in terms of oxides thereof, has a low molding temperature, excellent durability, and a reduced number of surface defects. An information recording medium having such a glass substrate and a magnetic layer formed thereon has excellent low-temperature workability and excellent weathering resistance. The glass substrate is suitable for perpendicular magnetic recording because the glass composition suppresses alkali elution from the glass substrate and the glass substrate has substantially no surface-attached foreign matter having a height of about 10 nm or less and having SiO₂ as a main component thereof.

### BACKGROUND OF THE INVENTION

1. Field of the Invention

The present invention relates to an information recording medium glass substrate and an information recording medium, and more specifically relates to an information recording medium glass substrate comprising an alkali metal-containing glass substrate and an information recording medium using the information recording medium glass substrate.

2. Description of the Related Art

In recent years, demand has prompted not only an increase in the recording density of magnetic disks, but also an improvement in the performance of the magnetic layer on which digital signals are recorded and of various component elements, such as the magnetic head that is involved in reading of recordings and the recording medium substrate. Amid studies aimed at meeting these demands, use of a glass substrate, instead of the conventionally-used aluminum substrate, has started to receive attention.

The reasons for glass substrates receiving attention as magnetic disk substrates include the following. (i) If a glass material is used, then it is easy to make the substrate be a thin plate which is required for decreasing size and increasing density. (ii) With a glass material, it is easy to secure a substrate surface flatness which enables a low magnetic head flying height. (iii) Glass substrates have a higher potential than aluminum substrates. Moreover, a glass material can be molded easily into a disk shape by applying pressure at above the softening temperature thereof and, hence, one more reason is having the ability to manufacture a disk-shaped substrate at a low cost by using glass.

When reducing the cost in the manufacture of such glass substrates is considered, the lifetime of the press and mold used in substrate molding must not be shortened. Hence, the molding temperature is preferably as low as possible.

Generally, to reduce the molding temperature of a glass substrate, alkali metals such as Li, Na and K are added to the glass raw material. However, on the other hand, it is known that such addition of alkali metals to a glass substrate has great disadvantages including causing corrosion of the magnetic layer of the information recording medium, causing degradation of any surface lubricating layer, and damaging the magnetic head due to production of a surface deposit. In this way, from the viewpoint of using a glass material as a substrate material for an information recording medium substrate, it is desirable to suppress elution of alkali metal ions as much as possible.

From this viewpoint, as seen for example in Japanese Patent Application Laid-open No. 2003-30816, the present inventors have previously disclosed a method for preventing elution of alkali metal ions from glass to which alkali metals, such as Li, Na and K, have been added and have provided a low-cost, highly reliable glass substrate that can cope with a high recording density.

In recent years, there has been a transition in the recording method for information recording media from a conventional longitudinal magnetic recording method to a perpendicular magnetic recording method. With the longitudinal magnetic recording method, the magnetic thermal stability is low, and hence as the magnetic recording bit size is reduced, recordings become easily deleted due to the magnetic environment of geomagnetism and so on or the temperature environment, the limit of the recording density being approximately 140 Gbts/in². On the other hand, with the perpendicular magnetic recording method, thermal stability is high even if the bit size is reduced and, hence, the limit of the recording density is said to be 700 to 800 Gbts/in², with 300 Gbts/in² already actually having been attained at the research stage.

With the conventional longitudinal recording method, lines of microscopic height known as texture are provided so as to align the crystal orientation of the magnetic film in the circumferential direction of the substrate and any foreign matter attached to the substrate surface is removed at the same time through this processing. On the other hand, with the perpendicular recording method, if such texturing is carried out, then the crystal orientation of the magnetic film deviates from the perpendicular direction and, hence, good magnetic characteristics can no longer be obtained. Removal of foreign matter attached to the substrate surface, which had been a by-product of texturing with the longitudinal recording method, thus becomes impossible. Hence, with the perpendicular recording method, the presence of trace amounts of substrate surface-attached matter which was not a problem with the longitudinal recording method has come to the fore as a problem.

In recent studies, it has been found that even with the same perpendicular recording method, there is more problematic substrate surface-attached foreign matter with a glass magnetic recording medium using a glass substrate than with an aluminum magnetic recording medium using an aluminum substrate. As a result of analysis, it has been found that the foreign matter attached to the surface of the glass substrate has a height of approximately 10 nm and is matter having SiO₂ as a main component thereof. The present inventors have conjectured that this is because glass shavings produced in a final glass substrate polishing step or silicate contained in a colloidal silica solution that has not completely grown to a desired particle size (hereinafter referred to as “colloidal silica silicate impurity”) chemically bonds or reattaches to the glass surface and cannot be removed through washing in a subsequent step.

It is thus an object of the present invention to reduce the amount of glass substrate surface-attached foreign matter having a height of approximately 10 nm or less and having SiO₂ as a main component thereof which was not a problem conventionally due to there being a texturing step, and to thus provide an alkali metal-containing glass substrate (information recording medium glass substrate) that can be used with the perpendicular recording method, an information recording medium using such an information recording medium glass substrate, and methods of manufacturing the information recording medium glass substrate and the information recording medium.

### SUMMARY OF THE INVENTION

The present inventors carried out various studies to reduce the amount of glass substrate surface-attached foreign matter of height approximately 10 nm or less and having SiO₂ as a main component thereof which was not a problem conventionally due to there being a texturing step as described above.

As a result, it was found that if a glass substrate contains more than a certain specified amount of the alkaline earth metals Mg, Ca, Sr and Ba, then the Mg, Ca, Sr and Ba promote aggregation of a colloidal silica silicate impurity or glass shavings in the final polishing step. Hence, surface-attached foreign matter having SiO₂ as a main component thereof is formed and cannot be sufficiently removed in a glass substrate surface washing step.

Meanwhile, the present inventors reconfirmed that the method disclosed in Japanese Patent Application Laid-open No. 2003-30816 is excellent for achieving both a reduction in molding temperature and a reduction in alkali elution from the glass substrate, and based on the composition therein, optimized the content of Mg, Ca, Sr and Ba, thus accomplishing the present invention.

An information recording medium glass substrate according to the present invention has a composition in which contents of Si, Al, B, alkali metals R, and Zn as molar proportions in terms of oxides satisfy (I)-(V):
0.8≦(R₂O content−Al₂O₃ content)/B₂O₃ content≦1.2, (I)
9.0 mol %≦B₂O₃ content≦14.0 mol %, (II)
3.0 mol %≦Al₂O₃ content≦7.0 mol %, (III)
6.0 mol %≦ZnO content≦18.0 mol %, and (IV)
40.0 mol %≦SiO₂ content. (V)

For the information recording medium glass substrate according to the present invention, the composition thereof preferably further satisfies (VI):
0≦MgO content+CaO content+SrO content+BaO content<0.3 mol %. (VI)
Effects of the Invention

For the information recording medium glass substrate of the present invention, due to the composition of the glass material of the substrate being controlled as described above, a glass substrate can be provided that has no surface attached foreign matter and hence is sufficient for a perpendicular recording method. Moreover, an information recording medium using this substrate is a magnetic recording medium that has excellent weathering resistance and is suitable for the perpendicular recording method.

### BRIEF DESCRIPTION OF THE DRAWINGS

FIG. 1 is a schematic plan view showing an example of the information recording medium glass substrate of the present invention; and

FIG. 2 is a schematic sectional view showing an example of the information recording medium of the present invention.

### DESCRIPTION OF THE PREFERRED EMBODIMENTS

A first aspect of the present invention relates to an information recording medium glass substrate. For the information recording medium glass substrate according to the present invention, to reduce alkali elution from the glass substrate, the contents of Si, Al, B, alkali metals (R), and Zn contained in the composition of the information recording medium glass substrate as molar proportions in terms of oxides satisfy:
0.8≦(R₂O content−Al₂O₃ content)/B₂O₃ content≦1.2, (I)
9.0 mol %≦B₂O₃ content≦14.0 mol %, (II)
3.0 mol %≦Al₂O₃ content≦7.0 mol %, (III)
6.0 mol %≦ZnO content≦18.0 mol %, and (IV)
40.0 mol %≦SiO₂ content. (V)

Furthermore, the composition of the information recording medium glass substrate preferably further satisfies (VI):
0≦MgO content+CaO content+SrO content+BaO content<0.3 mol %. (VI)

B₂O₃ is a component for forming borosilicate glass together with SiO₂, and has the effect of lowering the melt viscosity and lowering the melting temperature of the glass. If the B₂O₃ content is less than the above lower limit, then this effect is insufficient, whereas if the B₂O₃ content is greater than the above upper limit, then the amount of alkali metal oxides required for satisfying above equation (I) becomes too high, and hence the problem of elution of the alkali metals increasing arises.

Al₂O₃ is a component for stabilizing the glass and reducing the density of the glass. If the Al₂O₃ content is less than the above lower limit, then this effect is insufficient, whereas if the Al₂O₃ content is greater than the above upper limit, then the glass becomes hard and hence low-temperature pressing becomes difficult, and moreover the amount of alkali metal oxides required for satisfying above equation (I) becomes too high, and hence the problem of elution of the alkali metals increasing arises.

ZnO has the effect of lowering the melt viscosity of the glass, enabling low-temperature pressing, and moreover suppressing elution of the alkali metals. If the ZnO content is less than the above lower limit; then this effect is insufficient, whereas if the ZnO content is greater than the above upper limit, then a problem arises that the glass becomes inhomogeneous, for example dendrites become prone to segregate.

For the information recording medium glass substrate of the present invention, due to making the glass composition satisfy above (I) to (V), an information recording medium substrate can be obtained for which there is little or no elution of the alkali metals, the low-temperature workability is excellent, and there are no streaked surface defects.

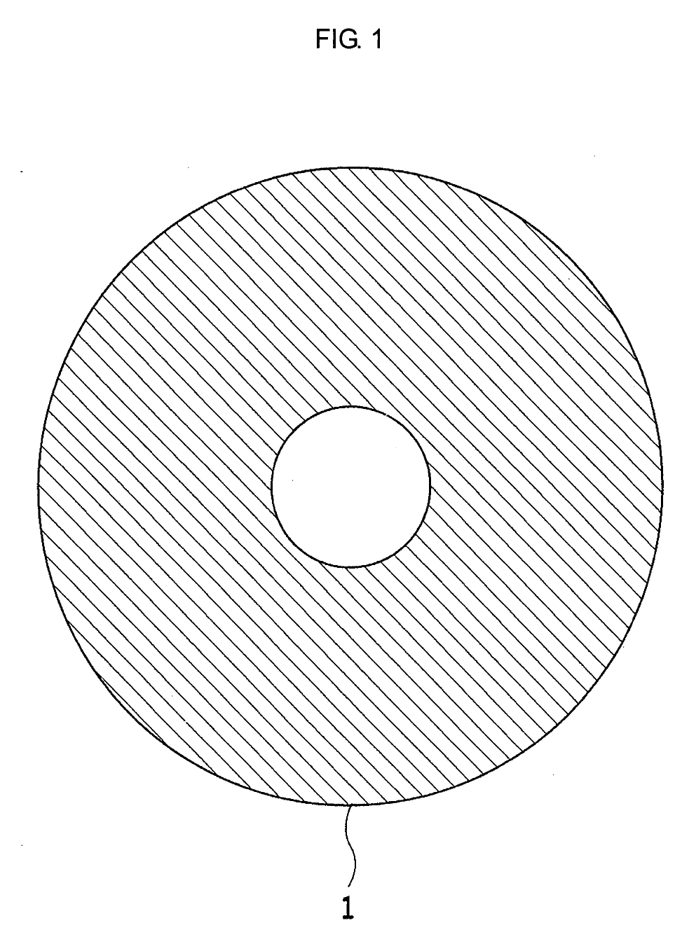

FIG. 1 is a schematic view for explaining an example of the information recording medium glass substrate according to the present invention. As can be seen from FIG. 1 the information recording medium glass substrate 1 is constituted from a disk-shaped alkali metal-containing glass substrate having a circular hole 2 formed in the center thereof.

As one example, the alkali metal-containing glass substrate can be manufactured through the following procedure. First, a glass powder containing additives to give the desired composition is melted, so as to manufacture an oval glass mass of mass approximately 6 g, thickness approximately 8 mm, and diameter approximately 23 mm (hereinafter referred to as the “marble”). Next, the marble is molded at a temperature around Ts, thus obtaining a disk-shaped glass substrate of thickness 0.635 mm and diameter 65 mm. Next, a 20 mm-diameter hole is formed in a central portion of the disk-shaped glass substrate, and furthermore to increase the mechanical strength of the substrate, ordinary chemical strengthening is carried out. The chemical strengthening is carried out, for example, by immersing the glass substrate for 1 to 5 hours in a molten liquid comprising a mixture of NaNO₃ and KNO₃ in a ratio of 0.4:0.6 maintained at 350 to 400° C. Finally, the glass substrate is washed with pure water, and is then further subjected to scrubbing, washing with pure water, washing with isopropyl alcohol (IPA), and drying.

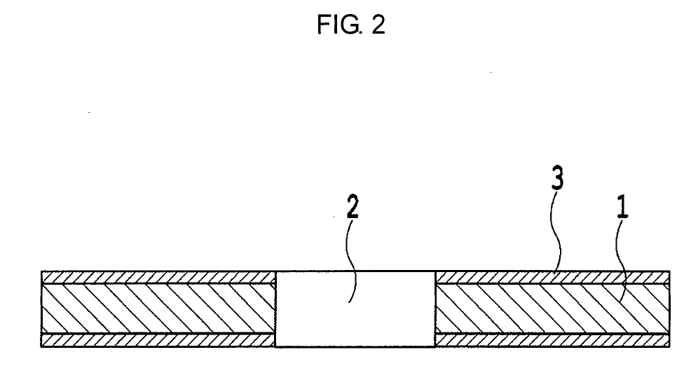

A second aspect of the present invention relates to a magnetic information recording medium having the information recording medium substrate 1 described in the first aspect of the present invention. That is, as shown in FIG. 2, the magnetic information recording medium according to the present invention has an information recording medium glass substrate 1 comprising an alkali metal-containing glass substrate, and a magnetic layer 3 formed on the glass substrate 1. As the information recording medium glass substrate 1, the information recording medium glass substrate described in-the first aspect of the present invention above is used.

The information recording medium of the present invention has an alkali metal-containing glass substrate having a glass composition as described above, whereby there is little or no, i.e., substantially no, attached foreign matter having SiO₂ as a main component thereof on the glass substrate surface, and moreover there is little or no, i.e., substantially no, alkali elution from the glass substrate. The magnetic information recording medium constituted in this way may further have an underlayer, a protective layer, a lubricating layer and so on (not shown) as required.

A method of manufacturing the information recording medium substrate according to the present invention comprises preparing an alkali metal-containing glass material having a glass composition that contains B, Al, alkali metals, Zn, and Si, and satisfies (I) to (V) above, and molding this glass material.

To give an example of the manufacturing method, a glass powder having a composition as above is melted, so as to manufacture, for example, an oval glass mass of mass approximately 6 g, thickness approximately 8 mm, and diameter approximately 23 mm (hereinafter referred to as the “marble”). Next, the marble is molded at a temperature around Ts into a disk shape of, for example, thickness 0.635 mm and diameter 65 mm, thus obtaining a glass substrate. A 20 mm-diameter hole is then formed in a central portion of the glass substrate obtained, whereby the information recording medium substrate is obtained. To increase the mechanical strength, the substrate is preferably subjected to chemical strengthening. An example of the chemical strengthening method is a method of treating in a mixed liquid of NaNO₃ and KNO₃. An example thereof is a method of immersing for 1 to 5 hours in a mixed molten liquid comprising NaNO₃ and KNO₃ in a ratio of 2:3 held at 350 to 400“C. Washing is preferably carried out after the chemical strengthening treatment.

Next, the information recording medium of the present invention will be described with reference to FIG. 2. FIG. 2 is a schematic sectional layered view for explaining an example of the information recording medium according to the present invention. As shown in FIG. 2, the magnetic information recording medium of the present invention has an information recording medium substrate 1 comprising the alkali metal-containing glass substrate described above, and a magnetic layer 3 formed on the substrate 1.

Any ordinary magnetic material ordinarily used for the magnetic layer of an information recording medium can be used for the magnetic layer. Through the information recording medium of the present invention having an alkali metal-containing glass substrate constituted from a glass composition satisfying the above relational equations, there is little or no alkali elution from the substrate. The magnetic information recording medium constituted in this way may further have an underlayer, a protective layer, a lubricating layer and so on as required. The composition used for each of these layers may be in accordance with such a layer as ordinarily used in an information recording medium.

To attain a high-performance magnetic information recording medium, it is preferable to provide an underlayer on the substrate so as to control the orientation of the magnetic layer.

In this way, according to the present invention, because the alkali metal-containing glass substrate has a composition satisfying the above relational equations, alkali elution from the information recording medium substrate is suppressed, and hence corrosion, degradation, damage and so on of the magnetic information recording medium due to eluted alkali can be prevented. As a result, a magnetic information recording medium having excellent durability and high reliability can be provided. Note that it should easily be understood by a person skilled in the art that there are no particular limitations on the structure or shape of the magnetic information recording medium, various modifications being possible.

### WORKING EXAMPLES

Following is a more detailed description of the present invention through working examples. However, the present invention is not limited thereto, but rather it goes without saying that various modifications are possible within a scope such as to not deviate from the gist of the present invention.

### Working Examples 1 to 34, Comparative Examples 1 to 66, and Reference Examples 1 and 2

A raw material powder having a composition as shown in Tables 1 to 6.was weighed out and mixed, and then put into a crucible, and melted at 1300 to 1500° C. The molten glass was poured out from the crucible into a carbon mold, so as to manufacture a marble of mass approximately 6 g, thickness approximately 8 mm, and diameter approximately 23 mm. Next, the marble was introduced into a molding mold before cooling too much, and while maintaining the mold at a temperature around Ts, pressure was applied for 3 minutes at 0.2 to 0.6 t/cm². Through this operation, a disk-shaped glass plate of diameter 65 mm and thickness 0.635 mm was obtained. Next, a 20 mm-diameter hole was formed in a central portion of the glass plate, and inner and outer peripheral edges were chamfered, and then primary polishing using ceria abrasive grains was carried out, followed by secondary polishing using colloidal silica. After the secondary polishing had been completed, the glass substrate was subjected to chemical washing, scrubbing, and ultrasonic washing, and then drying.

After the drying had been completed, evaluation of SiO₂ attached matter of height approximately 10 nm on the surface of the glass substrate was carried out using an optical appearance inspecting apparatus (NS1510H made by Hitachi High-Tech Electronics Engineering Co., Ltd.). Note, however, that the height of the SiO₂ glass substrate surface attached matter was too low, and hence the sensitivity was insufficient with the above appearance inspecting apparatus, and thus before the inspection, Cr metal was deposited to approximately 3 nm on the surface of the glass substrate, so as to emphasize the unevenness, and increase the amount of reflected light.

After counting the number of defects on the surface of the glass substrate using the appearance inspecting apparatus, portions where defects were present were marked, and it was checked using SEM-EDX whether or not the detected defects were SiO₂ surface attached matter. Shown in Tables 1 to 6 are the number of defects (number per surface) and the proportion of the number of defects accounted for by SiO₂ impurities (the SiO₂ impurity ratio).

Note that ΣR₂O in Tables 1 to 6 represents the total mol % of Li₂O, Na₂O and K₂O, ΣMO represents the total mol % of MgO, CaO, SrO and BaO, and Rf is the value represented by the following equation:
Rf=(ΣR₂O−Al₂O₃ content)/B₂O₃ content (units: mol %).
Evaluation of Alkali Elution Amount

Moreover, to evaluate the alkali elution prevention effect, the alkali elution amount was analyzed from the glass substrate in accordance with the following procedure.

(i) 10 mL of pure water was put into a 0.5 L lidded TEFLON (registered trademark) container, and one substrate to be evaluated was also put in.

(ii) The container was put into an 80° C. thermostatic oven, and left for 24 hours.

(iii) The TEFLON (registered trademark) container was taken out from the thermostatic oven, the pure water was collected, and alkali elements that had eluted into the pure water were examined by ICP analysis.

(iv) The total alkali elution amount per unit area was calculated from the ICP analysis values obtained.

For each substrate obtained, results for Ts, the alkali elution amount, the number of defects per surface of the glass substrate as examined using the appearance inspecting apparatus, and the SiO₂ impurity ratio out of the detected defects as examined using SEM-EDX are shown in Tables 1 to 6.

Judgment results are indicated in the tables as “∘” and “•” in the judgment column. The symbol “∘” indicates substrates for which Ts was not more than 650° C., the alkali elution amount was not more than 5.0 mg/m², the number of defects was not more than 50 per surface, and the SiO₂ impurity ratio was not more than 10%, whereas the symbol “•” indicates substrates for which Ts was more than 650° C., or the alkali elution amount was more than 5.0 mg/m², or the number of defects was more than 50 per surface, or the SiO₂ impurity ratio was more than 10%. Note that here, the ZnO content was fixed at 12 mol %, and the Li₂O content: Na₂O content: K₂O content ratio was fixed at approximately 10:6:1.

TABLE 1

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 1 | 53.8 | 12.0 | 5.0 | 10.0 | 6.0 | 1.0 | 17.0 | 12.0 | 0.2 | 0.0 | 0.0 | 0.0 | 0.2 | 1.0 | 605 | 2.2 | 9.9 | 9.0 | ◯ |
| 2 | 53.7 | 12.0 | 5.0 | 10.0 | 6.0 | 1.0 | 17.0 | 12.0 | 0.3 | 0.0 | 0.0 | 0.0 | 0.3 | 1.0 | 605 | 2.2 | 18.8 | 52.0 | ● |
| 3 | 53.8 | 12.0 | 5.0 | 10.0 | 6.0 | 1.0 | 17.0 | 12.0 | 0.0 | 0.2 | 0.0 | 0.0 | 0.2 | 1.0 | 605 | 2.2 | 9.9 | 9.0 | ◯ |
| 4 | 53.7 | 12.0 | 5.0 | 10.0 | 6.0 | 1.0 | 17.0 | 12.0 | 0.0 | 0.3 | 0.0 | 0.0 | 0.3 | 1.0 | 605 | 2.2 | 19.6 | 54.0 | ● |
| 5 | 53.8 | 12.0 | 5.0 | 10.0 | 6.0 | 1.0 | 17.0 | 12.0 | 0.0 | 0.0 | 0.2 | 0.0 | 0.2 | 1.0 | 605 | 2.2 | 9.9 | 9.0 | ◯ |
| 6 | 53.7 | 12.0 | 5.0 | 10.0 | 6.0 | 1.0 | 17.0 | 12.0 | 0.0 | 0.0 | 0.3 | 0.0 | 0.3 | 1.0 | 605 | 2.2 | 20.5 | 56.0 | ● |
| 7 | 53.8 | 12.0 | 5.0 | 10.0 | 6.0 | 1.0 | 17.0 | 12.0 | 0.0 | 0.0 | 0.0 | 0.2 | 0.2 | 1.0 | 605 | 2.2 | 9.9 | 9.0 | ◯ |
| 8 | 53.7 | 12.0 | 5.0 | 10.0 | 6.0 | 1.0 | 17.0 | 12.0 | 0.0 | 0.0 | 0.0 | 0.3 | 0.3 | 1.0 | 605 | 2.2 | 23.7 | 62.0 | ● |
| 9 | 53.8 | 12.0 | 5.0 | 10.0 | 6.0 | 1.0 | 17.0 | 12.0 | 0.1 | 0.1 | 0.0 | 0.0 | 0.2 | 1.0 | 605 | 2.2 | 9.9 | 9.0 | ◯ |
| 10 | 53.8 | 12.0 | 5.0 | 10.0 | 6.0 | 1.0 | 17.0 | 12.0 | 0.1 | 0.0 | 0.1 | 0.0 | 0.2 | 1.0 | 605 | 2.2 | 9.8 | 8.0 | ◯ |
| 11 | 53.8 | 12.0 | 5.0 | 10.0 | 6.0 | 1.0 | 17.0 | 12.0 | 0.1 | 0.0 | 0.0 | 0.1 | 0.2 | 1.0 | 605 | 2.2 | 9.8 | 8.0 | ◯ |
| 12 | 53.8 | 12.0 | 5.0 | 10.0 | 6.0 | 1.0 | 17.0 | 12.0 | 0.0 | 0.1 | 0.1 | 0.0 | 0.2 | 1.0 | 605 | 2.2 | 9.9 | 9.0 | ◯ |
| 13 | 53.8 | 12.0 | 5.0 | 10.0 | 6.0 | 1.0 | 17.0 | 12.0 | 0.0 | 0.1 | 0.0 | 0.1 | 0.2 | 1.0 | 605 | 2.2 | 9.8 | 8.0 | ◯ |
| 14 | 53.8 | 12.0 | 5.0 | 10.0 | 6.0 | 1.0 | 17.0 | 12.0 | 0.0 | 0.0 | 0.1 | 0.1 | 0.2 | 1.0 | 605 | 2.2 | 9.9 | 9.0 | ◯ |
| 15 | 53.7 | 12.0 | 5.0 | 10.0 | 6.0 | 1.0 | 17.0 | 12.0 | 0.1 | 0.1 | 0.1 | 0.0 | 0.3 | 1.0 | 605 | 2.2 | 23.1 | 61.0 | ● |
| 16 | 53.7 | 12.0 | 5.0 | 10.0 | 6.0 | 1.0 | 17.0 | 12.0 | 0.1 | 0.1 | 0.0 | 0.1 | 0.3 | 1.0 | 605 | 2.2 | 21.4 | 58.0 | ● |
| 17 | 53.7 | 12.0 | 5.0 | 10.0 | 6.0 | 1.0 | 17.0 | 12.0 | 0.1 | 0.0 | 0.1 | 0.1 | 0.3 | 1.0 | 605 | 2.2 | 20.5 | 53.0 | ● |
| 18 | 53.7 | 12.0 | 5.0 | 10.0 | 6.0 | 1.0 | 17.0 | 12.0 | 0.0 | 0.1 | 0.1 | 0.1 | 0.3 | 1.0 | 605 | 2.2 | 19.1 | 53.0 | ● |

TABLE 2

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 19 | 61.4 | 12.0 | 3.0 | 6.7 | 4.0 | 0.7 | 11.4 | 12.0 | 0.1 | 0.1 | 0.0 | 0.0 | 0.2 | 0.7 | 635 | 5.1 | 9.7 | 7.0 | ● |
| 20 | 61.3 | 12.0 | 3.0 | 6.7 | 4.0 | 0.7 | 11.4 | 12.0 | 0.1 | 0.1 | 0.1 | 0.0 | 0.3 | 0.7 | 635 | 5.1 | 20.5 | 56.0 | ● |
| 21 | 60.2 | 12.0 | 3.0 | 7.4 | 4.4 | 0.7 | 12.6 | 12.0 | 0.1 | 0.0 | 0.1 | 0.0 | 0.2 | 0.8 | 610 | 2.9 | 9.9 | 9.0 | ◯ |
| 22 | 60.1 | 12.0 | 3.0 | 7.4 | 4.4 | 0.7 | 12.6 | 12.0 | 0.1 | 0.0 | 0.1 | 0.1 | 0.3 | 0.8 | 610 | 2.9 | 20.9 | 57.0 | ● |
| 23 | 57.8 | 12.0 | 3.0 | 8.8 | 5.3 | 0.9 | 15.0 | 12.0 | 0.1 | 0.0 | 0.0 | 0.1 | 0.2 | 1.0 | 600 | 3.0 | 9.7 | 7.0 | ◯ |
| 24 | 57.7 | 12.0 | 3.0 | 8.8 | 5.3 | 0.9 | 15.0 | 12.0 | 0.1 | 0.1 | 0.0 | 0.1 | 0.3 | 1.0 | 600 | 3.0 | 20.5 | 56.0 | ● |
| 25 | 55.4 | 12.0 | 3.0 | 10.2 | 6.1 | 1.0 | 17.4 | 12.0 | 0.0 | 0.1 | 0.1 | 0.0 | 0.2 | 1.2 | 590 | 3.7 | 9.9 | 9.0 | ◯ |
| 26 | 55.3 | 12.0 | 3.0 | 10.2 | 6.1 | 1.0 | 17.4 | 12.0 | 0.0 | 0.1 | 0.1 | 0.1 | 0.3 | 1.2 | 590 | 3.7 | 20.0 | 55.0 | ● |
| 27 | 54.2 | 12.0 | 3.0 | 10.9 | 6.6 | 1.1 | 18.6 | 12.0 | 0.0 | 0.0 | 0.1 | 0.1 | 0.2 | 1.3 | 570 | 6.0 | 9.8 | 8.0 | ● |
| 28 | 58.0 | 14.0 | 3.0 | 7.5 | 4.5 | 0.8 | 12.8 | 12.0 | 0.1 | 0.1 | 0.0 | 0.0 | 0.2 | 0.7 | 630 | 5.3 | 9.7 | 7.0 | ● |
| 29 | 57.9 | 14.0 | 3.0 | 7.5 | 4.5 | 0.8 | 12.8 | 12.0 | 0.1 | 0.1 | 0.1 | 0.0 | 0.3 | 0.7 | 630 | 5.3 | 20.5 | 56.0 | ● |
| 30 | 56.6 | 14.0 | 3.0 | 8.4 | 5.0 | 0.8 | 14.2 | 12.0 | 0.1 | 0.0 | 0.1 | 0.0 | 0.2 | 0.8 | 605 | 2.8 | 9.9 | 9.0 | ◯ |
| 31 | 56.5 | 14.0 | 3.0 | 8.4 | 5.0 | 0.8 | 14.2 | 12.0 | 0.1 | 0.0 | 0.1 | 0.1 | 0.3 | 0.8 | 605 | 2.8 | 21.4 | 58.0 | ● |
| 32 | 53.8 | 14.0 | 3.0 | 10.0 | 6.0 | 1.0 | 17.0 | 12.0 | 0.1 | 0.0 | 0.0 | 0.1 | 0.2 | 1.0 | 600 | 2.9 | 9.8 | 8.0 | ◯ |
| 33 | 53.7 | 14.0 | 3.0 | 10.0 | 6.0 | 1.0 | 17.0 | 12.0 | 0.1 | 0.1 | 0.0 | 0.1 | 0.3 | 1.0 | 600 | 2.9 | 20.5 | 56.0 | ● |
| 34 | 51.0 | 14.0 | 3.0 | 11.6 | 7.0 | 1.2 | 19.8 | 12.0 | 0.0 | 0.1 | 0.1 | 0.0 | 0.2 | 1.2 | 590 | 3.8 | 9.7 | 7.0 | ◯ |
| 35 | 50.9 | 14.0 | 3.0 | 11.6 | 7.0 | 1.2 | 19.8 | 12.0 | 0.0 | 0.1 | 0.1 | 0.1 | 0.3 | 1.2 | 590 | 3.8 | 19.6 | 54.0 | ● |
| 36 | 51.8 | 14.0 | 3.0 | 12.5 | 7.5 | 1.2 | 21.2 | 12.0 | 0.0 | 0.0 | 0.1 | 0.1 | 0.2 | 1.3 | 570 | 5.8 | 9.9 | 9.0 | ● |

TABLE 3

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 37 | 51.8 | 15.0 | 3.0 | 10.6 | 6.4 | 1.1 | 18.0 | 12.0 | 0.1 | 0.1 | 0.0 | 0.0 | 0.2 | 1.0 | 605 | 5.2 | 9.9 | 90 | ● |
| 38 | 51.7 | 15.0 | 3.0 | 10.6 | 6.4 | 1.1 | 18.0 | 12.0 | 0.1 | 0.1 | 0.1 | 0.0 | 0.3 | 1.0 | 605 | 5.2 | 20.9 | 57.0 | ● |
| 39 | 61.8 | 8.0 | 5.0 | 7.6 | 4.6 | 0.8 | 13.0 | 12.0 | 0.1 | 0.0 | 0.1 | 0.0 | 0.2 | 1.0 | 655 | 3.9 | 9.8 | 8.0 | ● |
| 40 | 61.7 | 9.0 | 5.0 | 7.6 | 4.6 | 0.8 | 13.0 | 12.0 | 0.1 | 0.0 | 0.1 | 0.1 | 0.3 | 1.0 | 655 | 3.9 | 21.4 | 58.0 | ● |
| 41 | 62.5 | 9.0 | 5.0 | 6.6 | 4.0 | 0.7 | 11.3 | 12.0 | 0.1 | 0.1 | 0.0 | 0.0 | 0.2 | 0.7 | 640 | 5.2 | 9.8 | 8.0 | ● |
| 42 | 62.4 | 9.0 | 5.0 | 6.6 | 4.0 | 0.7 | 11.3 | 12.0 | 0.1 | 0.1 | 0.1 | 0.0 | 0.3 | 0.7 | 640 | 5.2 | 19.6 | 54.0 | ● |
| 43 | 61.6 | 9.0 | 5.0 | 7.2 | 4.3 | 0.7 | 12.2 | 12.0 | 0.1 | 0.0 | 0.1 | 0.0 | 0.2 | 0.8 | 615 | 2.4 | 9.7 | 7.0 | ◯ |
| 44 | 61.5 | 9.0 | 5.0 | 7.2 | 4.3 | 0.7 | 12.2 | 12.0 | 0.1 | 0.0 | 0.1 | 0.1 | 0.3 | 0.8 | 615 | 2.4 | 20.5 | 56.0 | ● |
| 45 | 59.8 | 9.0 | 5.0 | 8.2 | 4.9 | 0.8 | 14.0 | 12.0 | 0.1 | 0.0 | 0.0 | 0.1 | 0.2 | 1.0 | 605 | 2.5 | 9.8 | 8.0 | ◯ |
| 46 | 59.7 | 9.0 | 5.0 | 8.2 | 4.9 | 0.8 | 14.0 | 12.0 | 0.1 | 0.1 | 0.0 | 0.1 | 0.3 | 1.0 | 605 | 2.5 | 20.0 | 55.0 | ● |
| 47 | 58.0 | 9.0 | 5.0 | 9.3 | 5.6 | 0.9 | 15.8 | 12.0 | 0.1 | 0.1 | 0.1 | 0.0 | 0.2 | 1.2 | 600 | 3.4 | 9.9 | 9.0 | ◯ |
| 48 | 57.9 | 9.0 | 5.0 | 9.3 | 5.6 | 0.9 | 15.8 | 12.0 | 0.1 | 0.1 | 0.1 | 0.1 | 0.3 | 1.2 | 600 | 3.4 | 19.1 | 53.0 | ● |
| 49 | 57.1 | 9.0 | 5.0 | 9.8 | 5.9 | 1.0 | 16.7 | 12.0 | 0.1 | 0.0 | 0.1 | 0.1 | 0.2 | 1.3 | 575 | 5.4 | 9.8 | 8.0 | ● |
| 50 | 57.4 | 12.0 | 5.0 | 7.9 | 4.7 | 0.8 | 13.4 | 12.0 | 0.1 | 0.1 | 0.0 | 0.0 | 0.2 | 0.7 | 640 | 5.3 | 9.7 | 7.0 | ● |
| 51 | 57.3 | 12.0 | 5.0 | 7.9 | 4.7 | 0.8 | 13.4 | 12.0 | 0.1 | 0.1 | 0.1 | 0.0 | 0.3 | 0.7 | 640 | 5.3 | 19.1 | 53.0 | ● |
| 52 | 56.2 | 12.0 | 5.0 | 8.6 | 5.2 | 0.9 | 14.6 | 12.0 | 0.1 | 0.0 | 0.1 | 0.0 | 0.2 | 0.8 | 615 | 2.1 | 9.8 | 8.0 | ◯ |
| 53 | 56.1 | 12.0 | 5.0 | 8.6 | 5.2 | 0.9 | 14.6 | 12.0 | 0.1 | 0.0 | 0.1 | 0.1 | 0.3 | 0.8 | 615 | 2.1 | 20.5 | 56.0 | ● |
| 54 | 53.8 | 12.0 | 5.0 | 10.0 | 6.0 | 1.0 | 17.0 | 12.0 | 0.1 | 0.0 | 0.0 | 0.1 | 0.2 | 1.0 | 605 | 2.2 | 9.7 | 7.0 | ◯ |

TABLE 4

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 55 | 53.7 | 12.0 | 5.0 | 10.0 | 6.0 | 1.0 | 17.0 | 17.0 | 0.1 | 0.1 | 0.0 | 0.1 | 0.3 | 1.0 | 605 | 2.2 | 21.4 | 58.0 | ● |
| 56 | 51.4 | 12.0 | 5.0 | 11.4 | 6.8 | 1.1 | 19.4 | 19.4 | 0.0 | 0.1 | 0.1 | 0.0 | 0.2 | 1.2 | 595 | 3.1 | 9.9 | 9.0 | ◯ |
| 57 | 51.3 | 12.0 | 5.0 | 11.4 | 6.8 | 1.1 | 19.4 | 19.4 | 0.0 | 0.1 | 0.1 | 0.1 | 0.3 | 1.2 | 595 | 3.1 | 18.8 | 52.0 | ● |
| 58 | 50.2 | 12.0 | 5.0 | 12.1 | 7.3 | 1.2 | 20.6 | 20.6 | 0.0 | 0.0 | 0.1 | 0.1 | 0.2 | 1.3 | 575 | 5.1 | 9.8 | 8.0 | ● |
| 59 | 68.8 | 14.0 | 5.0 | 8.7 | 5.2 | 0.9 | 14.8 | 12.0 | 0.1 | 0.1 | 0.0 | 0.0 | 0.2 | 0.7 | 630 | 5.2 | 9.8 | 8.0 | ● |
| 60 | 68.7 | 14.0 | 5.0 | 8.7 | 5.2 | 0.9 | 14.8 | 12.0 | 0.1 | 0.1 | 0.1 | 0.0 | 0.3 | 0.7 | 630 | 5.2 | 20.5 | 56.0 | ● |
| 61 | 68.8 | 14.0 | 5.0 | 9.5 | 5.7 | 1.0 | 16.2 | 12.0 | 0.1 | 0.0 | 0.1 | 0.0 | 0.2 | 0.8 | 610 | 2.5 | 9.7 | 7.0 | ◯ |
| 62 | 68.7 | 14.0 | 5.0 | 9.5 | 5.7 | 1.0 | 16.2 | 12.0 | 0.1 | 0.0 | 0.1 | 0.1 | 0.3 | 0.8 | 610 | 2.5 | 19.6 | 54.0 | ● |
| 63 | 68.8 | 14.0 | 5.0 | 11.2 | 6.7 | 1.1 | 19.0 | 12.0 | 0.1 | 0.0 | 0.0 | 0.1 | 0.2 | 1.0 | 605 | 2.7 | 9.7 | 7.0 | ◯ |
| 64 | 68.7 | 14.0 | 5.0 | 11.2 | 6.7 | 1.1 | 19.0 | 12.0 | 0.1 | 0.1 | 0.0 | 0.1 | 0.3 | 1.0 | 605 | 2.7 | 19.1 | 53.0 | ● |
| 65 | 68.8 | 14.0 | 5.0 | 12.8 | 7.7 | 1.3 | 21.8 | 12.0 | 0.0 | 0.1 | 0.1 | 0.0 | 0.2 | 1.2 | 590 | 3.6 | 9.9 | 9.0 | ◯ |
| 66 | 68.7 | 14.0 | 5.0 | 12.8 | 7.7 | 1.3 | 21.8 | 12.0 | 0.0 | 0.1 | 0.1 | 0.1 | 0.3 | 1.2 | 590 | 3.6 | 20.5 | 56.0 | ● |
| 67 | 68.8 | 14.0 | 5.0 | 13.6 | 8.2 | 1.4 | 23.2 | 12.0 | 0.0 | 0.0 | 0.1 | 0.1 | 0.2 | 1.3 | 570 | 5.5 | 9.8 | 8.0 | ● |
| 68 | 67.8 | 15.0 | 5.0 | 11.8 | 7.1 | 1.2 | 20.0 | 12.0 | 0.1 | 0.0 | 0.1 | 0.0 | 0.2 | 1.0 | 610 | 5.7 | 9.7 | 7.0 | ● |
| 69 | 67.7 | 15.0 | 5.0 | 11.8 | 7.1 | 1.2 | 20.0 | 12.0 | 0.1 | 0.0 | 0.1 | 0.1 | 0.3 | 1.0 | 610 | 5.7 | 20.5 | 56.0 | ● |
| 70 | 72.8 | 8.0 | 7.0 | 8.8 | 5.3 | 0.9 | 15.0 | 12.0 | 0.1 | 0.0 | 0.1 | 0.0 | 0.2 | 1.0 | 655 | 4.0 | 9.8 | 8.0 | ● |
| 71 | 72.7 | 8.0 | 7.0 | 8.8 | 5.3 | 0.9 | 15.0 | 12.0 | 0.1 | 0.0 | 0.1 | 0.1 | 0.3 | 1.0 | 655 | 4.0 | 20.0 | 55.0 | ● |
| 72 | 71.8 | 9.0 | 7.0 | 7.8 | 4.7 | 0.8 | 13.3 | 12.0 | 0.1 | 0.1 | 0.0 | 0.0 | 0.2 | 0.7 | 645 | 5.1 | 9.7 | 7.0 | ● |

TABLE 5

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 73 | 71.7 | 9.0 | 7.0 | 7.8 | 4.7 | 0.8 | 13.3 | 12.0 | 0.1 | 0.1 | 0.1 | 0.0 | 0.3 | 0.7 | 645 | 5.1 | 20.0 | 55.0 | ● |
| 74 | 71.8 | 9.0 | 7.0 | 8.4 | 5.0 | 0.8 | 14.2 | 12.0 | 0.1 | 0.0 | 0.1 | 0.0 | 0.2 | 0.8 | 615 | 2.3 | 9.9 | 9.0 | ◯ |
| 75 | 71.7 | 9.0 | 7.0 | 8.4 | 5.0 | 0.8 | 14.2 | 12.0 | 0.1 | 0.0 | 0.1 | 0.1 | 0.3 | 0.8 | 615 | 2.3 | 19.6 | 54.0 | ● |
| 76 | 71.8 | 9.0 | 7.0 | 9.4 | 5.6 | 0.9 | 16.0 | 12.0 | 0.1 | 0.0 | 0.0 | 0.1 | 0.2 | 1.0 | 610 | 2.3 | 9.8 | 8.0 | ◯ |
| 77 | 71.7 | 9.0 | 7.0 | 9.4 | 5.6 | 0.9 | 16.0 | 12.0 | 0.1 | 0.1 | 0.0 | 0.1 | 0.3 | 1.0 | 610 | 2.3 | 20.5 | 56.0 | ● |
| 78 | 71.8 | 9.0 | 7.0 | 10.5 | 6.3 | 1.0 | 17.8 | 12.0 | 0.0 | 0.1 | 0.1 | 0.0 | 0.2 | 1.2 | 600 | 3.1 | 9.9 | 9.0 | ◯ |
| 79 | 71.7 | 9.0 | 7.0 | 10.5 | 6.3 | 1.0 | 17.8 | 12.0 | 0.0 | 0.1 | 0.1 | 0.1 | 0.3 | 1.2 | 600 | 3.1 | 20.9 | 57.0 | ● |
| 80 | 71.8 | 9.0 | 7.0 | 11.0 | 6.6 | 1.1 | 18.7 | 12.0 | 0.0 | 0.0 | 0.1 | 0.1 | 0.2 | 1.3 | 580 | 5.2 | 9.7 | 7.0 | ● |
| 81 | 68.8 | 12.0 | 7.0 | 9.1 | 5.4 | 0.9 | 15.4 | 12.0 | 0.1 | 0.1 | 0.0 | 0.0 | 0.2 | 0.7 | 640 | 5.3 | 9.8 | 8.0 | ● |
| 82 | 68.7 | 12.0 | 7.0 | 9.1 | 5.4 | 0.9 | 15.4 | 12.0 | 0.1 | 0.1 | 0.1 | 0.0 | 0.3 | 0.7 | 640 | 5.3 | 20.5 | 56.0 | ● |
| 83 | 68.8 | 12.0 | 7.0 | 9.8 | 5.9 | 1.0 | 16.6 | 12.0 | 0.1 | 0.0 | 0.1 | 0.0 | 0.2 | 0.8 | 615 | 1.9 | 9.7 | 7.0 | ◯ |
| 84 | 68.7 | 12.0 | 7.0 | 9.8 | 5.9 | 1.0 | 16.6 | 12.0 | 0.1 | 0.0 | 0.1 | 0.1 | 0.3 | 0.8 | 615 | 1.9 | 20.0 | 55.0 | ● |
| 85 | 68.8 | 12.0 | 7.0 | 11.2 | 6.7 | 1.1 | 19.0 | 12.0 | 0.1 | 0.0 | 0.0 | 0.1 | 0.2 | 1.0 | 610 | 2.0 | 9.9 | 9.0 | ◯ |
| 86 | 68.7 | 12.0 | 7.0 | 11.2 | 6.7 | 1.1 | 19.0 | 12.0 | 0.1 | 0.1 | 0.0 | 0.1 | 0.3 | 1.0 | 610 | 2.0 | 20.9 | 57.0 | ● |
| 87 | 68.8 | 12.0 | 7.0 | 12.6 | 7.6 | 1.3 | 21.4 | 12.0 | 0.0 | 0.1 | 0.1 | 0.0 | 0.2 | 1.2 | 600 | 2.9 | 9.8 | 8.0 | ◯ |
| 88 | 68.7 | 12.0 | 7.0 | 12.6 | 7.6 | 1.3 | 21.4 | 12.0 | 0.0 | 0.1 | 0.1 | 0.1 | 0.3 | 1.2 | 600 | 2.9 | 21.4 | 58.0 | ● |
| 89 | 68.8 | 12.0 | 7.0 | 13.3 | 8.0 | 1.3 | 22.6 | 12.0 | 0.0 | 0.0 | 0.1 | 0.1 | 0.2 | 1.3 | 575 | 5.2 | 9.9 | 9.0 | ● |
| 90 | 66.8 | 14.0 | 7.0 | 9.9 | 5.9 | 1.0 | 16.8 | 12.0 | 0.1 | 0.1 | 0.0 | 0.0 | 0.2 | 0.7 | 630 | 5.4 | 9.7 | 7.0 | ● |

TABLE 6

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 91 | 66.7 | 14.0 | 7.0 | 9.9 | 5.9 | 1.0 | 16.8 | 12.0 | 0.1 | 0.1 | 0.1 | 0.0 | 0.3 | 0.7 | 630 | 5.4 | 20.0 | 55.0 | ● |
| 92 | 66.8 | 14.0 | 7.0 | 10.7 | 6.4 | 1.1 | 18.2 | 12.0 | 0.1 | 0.0 | 0.1 | 0.0 | 0.2 | 0.8 | 615 | 2.3 | 9.9 | 9.0 | ◯ |
| 93 | 66.7 | 14.0 | 7.0 | 10.7 | 6.4 | 1.1 | 18.2 | 12.0 | 0.1 | 0.0 | 0.1 | 0.1 | 0.3 | 0.8 | 615 | 2.3 | 21.4 | 58.0 | ● |
| 94 | 66.8 | 14.0 | 7.0 | 12.4 | 7.4 | 1.2 | 21.0 | 12.0 | 0.1 | 0.0 | 0.0 | 0.1 | 0.2 | 1.0 | 605 | 2.4 | 9.8 | 8.0 | ◯ |
| 95 | 66.7 | 14.0 | 7.0 | 12.4 | 7.4 | 1.2 | 21.0 | 12.0 | 0.1 | 0.1 | 0.0 | 0.1 | 0.3 | 1.0 | 605 | 2.4 | 22.0 | 59.0 | ● |
| 96 | 66.8 | 14.0 | 7.0 | 14.0 | 8.4 | 1.4 | 23.8 | 12.0 | 0.0 | 0.1 | 0.1 | 0.0 | 0.2 | 1.2 | 595 | 3.1 | 9.9 | 9.0 | ◯ |
| 97 | 66.7 | 14.0 | 7.0 | 14.0 | 8.4 | 1.4 | 23.8 | 12.0 | 0.0 | 0.1 | 0.1 | 0.1 | 0.3 | 1.2 | 595 | 3.1 | 20.9 | 57.0 | ● |
| 98 | 66.8 | 14.0 | 7.0 | 14.8 | 8.9 | 1.5 | 25.2 | 12.0 | 0.0 | 0.0 | 0.1 | 0.1 | 0.2 | 1.3 | 575 | 5.2 | 9.7 | 7.0 | ● |
| 99 | 65.8 | 15.0 | 7.0 | 12.9 | 7.8 | 1.3 | 22.0 | 12.0 | 0.1 | 0.0 | 0.1 | 0.0 | 0.2 | 1.0 | 610 | 6.1 | 9.9 | 9.0 | ● |
| 100 | 65.7 | 15.0 | 7.0 | 12.9 | 7.8 | 1.3 | 22.0 | 12.0 | 0.1 | 0.0 | 0.1 | 0.1 | 0.3 | 1.0 | 610 | 6.1 | 22.0 | 59.0 | ● |
| #1 | 79.0 | 14.0 | 7.0 | 12.4 | 7.4 | 1.2 | 21.0 | 0.0 | 0.0 | 0.0 | 0.0 | 0.0 | 0.0 | 1.0 | 630 | 2.4 | 58.0 | 8.0 | ● |
| #2 | 91.0 | 2.0 | 7.0 | 14.7 | 8.8 | 1.5 | 25.0 | 0.0 | 0.0 | 0.0 | 0.0 | 0.0 | 0.0 | 9.0 | 590 | 11.7 | 9.9 | 9.0 | ● |

Glass compositions that have been studied from hitherto are also shown in Table 6 as reference #1 and reference #2. Reference #1 is disclosed in Japanese Patent Application Laid-open No. 2003-30816, and does not contain an alkaline earth metal (Mg, Ca, Sr, or Ba), and hence the SiO₂ impurity ratio was low at 8%, but ZnO is not added, and hence there were streaked defects on the glass substrate surface. The number of defects was thus more than 50 per surface, and hence the judgment was “•”. Reference #2 was a substrate that does not contain ZnO, and yet streaked defects were not formed due to the marble dropping temperature being low, but the alkali elution amount was high at 11.7 mg/m². Generally, if B₂O₃ is added so as to reduce Ts while keeping down the alkali elution amount as in reference #1, then streaked defects are prone to form during the marble dropping.

In contrast, as can be seen from nos. 1, 3, 5 and-7 (working examples 1, 2, 3 and 4), nos. 9 to 14 (working examples 5 to 10), nos. 21, 23 and 25 (working examples 11, 12.and 13), nos. 30, 32 and 34 (working examples 14, 15 and 16), nos. 43, 45 and 47 (working examples 17, 18 and 19), nos. 52, 54 and 56 (working examples 20, 21 and 22), nos. 61, 63 and 65 (working examples 23, 24 and 25), nos. 74, 76 and 78 (working examples 26, 27 and 28), nos. 83, 85 and 87 (working examples 29, 30 and 31), and nos. 92, 94 and 96 (working examples 32, 33 and 34) in Tables 1 to 6, if the total amount of alkaline earth metals in terms of oxides is less than 0.3 mol, the ZnO content is 12 mol %, the Al₂O₃ content is in a range of from 3.0 to 7.0 mol %, the B_{2O}₃ content is in a range of from 9.0 to 14.0 mol %, and Rf is in a range of from 0.8 to 1.2, then Ts is not more than 650° C., the alkali elution amount is not more than 5.0 mg/m², the number of defects is not more than 50 per surface, and the SiO₂ impurity ratio is not more than 10%. That is, the judgment in Tables 1 to 6 is “∘” for all of these.

As shown by nos. 2, 4, 6 and 8 (comparative examples 1, 2, 3 and 4), nos. 15 to 18 (comparative examples 5 to 8), nos. 20, 22, 24 and 26 (comparative examples 10, 11, 12 and 13), nos. 29, 31, 33, 35 and 38 (comparative examples 16, 17, 18, 19 and 22), nos. 40, 42, 44, 46 and 48 (comparative examples 24, 26, 27, 28 and 29), nos. 51, 53, 55 and 57 (comparative examples 32, 33, 34 and 35), nos. 60, 62, 64 and 66 (comparative examples 38, 39, 40 and 41), nos. 69, 71, 73, 75, 77 and 79 (comparative examples 44, 46, 48, 49, 50 and 51), nos. 82, 84, 86 and 88 (comparative examples 54, 55, 56 and 57), nos. 91, 93, 95 and 97 (comparative examples 60, 61, 62 and 63), and no. 100 (comparative example 66) in Tables 1 to 6, if a large amount of alkaline earth metals are contained, then the SiO₂ impurity ratio increases. This is conjectured to be because silicate impurity present in the polishing step due to colloidal silica is prone to aggregating, and hence surface attached matter of height approximately 10 nm having SiO₂ as a main component thereof that cannot be completely removed in the washing step is prone to being formed on the substrate surface.

### Comparative Examples 67 to 78

Here, to explain the valid range for Al₂O₃, comparative examples in which the Al₂O₃ content is outside the range stipulated in the present invention are shown in Table 7. The sample manufacturing method was as in working example 1 described above, being carried out with the combinations shown in Table 7. The judgment criteria were also as before. Note that here, Rf was fixed at 1, which is the central value for the present invention.

TABLE 7

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 101 | 65.8 | 9.0 | 2.0 | 6.5 | 3.9 | 0.6 | 11.0 | 12.0 | 0.1 | 0.0 | 0.1 | 0.0 | 0.2 | 1.0 | 565 | 9.6 | 9.7 | 7.0 | ● |
| 102 | 65.7 | 9.0 | 2.0 | 6.5 | 3.9 | 0.6 | 11.0 | 12.0 | 0.1 | 0.0 | 0.1 | 0.1 | 0.3 | 1.0 | 565 | 9.6 | 20.0 | 55.0 | ● |
| 103 | 53.8 | 9.0 | 8.0 | 10.0 | 6.0 | 1.0 | 17.0 | 12.0 | 0.1 | 0.0 | 0.1 | 0.0 | 0.2 | 1.0 | 655 | 4.3 | 9.8 | 8.0 | ● |
| 104 | 53.7 | 9.0 | 8.0 | 10.0 | 6.0 | 1.0 | 17.0 | 12.0 | 0.1 | 0.0 | 0.1 | 0.1 | 0.3 | 1.0 | 655 | 4.3 | 20.9 | 57.0 | ● |
| 105 | 59.8 | 12.0 | 2.0 | 8.2 | 4.9 | 0.8 | 14.0 | 12.0 | 0.1 | 0.0 | 0.1 | 0.0 | 0.2 | 1.0 | 571 | 8.32 | 9.9 | 9.0 | ● |
| 106 | 59.7 | 12.0 | 2.0 | 8.2 | 4.9 | 0.8 | 14.0 | 12.0 | 0.1 | 0.0 | 0.1 | 0.1 | 0.3 | 1.0 | 571 | 8.3 | 20.0 | 55.0 | ● |
| 107 | 47.8 | 12.0 | 8.0 | 11.8 | 7.1 | 1.2 | 20.0 | 12.0 | 0.1 | 0.0 | 0.1 | 0.0 | 0.2 | 1.0 | 640 | 7.9 | 9.7 | 7.0 | ● |
| 108 | 47.7 | 12.0 | 8.0 | 11.8 | 7.1 | 1.2 | 20.0 | 12.0 | 0.1 | 0.0 | 0.1 | 0.1 | 0.3 | 1.0 | 640 | 7.9 | 20.5 | 56.0 | ● |
| 109 | 55.8 | 14.0 | 2.0 | 9.4 | 5.6 | 0.9 | 16.0 | 12.0 | 0.1 | 0.0 | 0.1 | 0.0 | 0.2 | 1.0 | 560 | 7.9 | 9.8 | 8.0 | ● |
| 110 | 55.7 | 14.0 | 2.0 | 9.4 | 5.6 | 0.9 | 16.0 | 12.0 | 0.1 | 0.0 | 0.1 | 0.1 | 0.3 | 1.0 | 560 | 7.9 | 20.9 | 57.0 | ● |
| 111 | 43.8 | 14.0 | 8.0 | 12.9 | 7.8 | 1.3 | 22.0 | 12.0 | 0.1 | 0.0 | 0.1 | 0.0 | 0.2 | 1.0 | 640 | 5.2 | 9.9 | 9.0 | ● |
| 112 | 43.7 | 14.0 | 8.0 | 12.9 | 7.8 | 1.3 | 22.0 | 12.0 | 0.1 | 0.0 | 0.1 | 0.1 | 0.3 | 1.0 | 640 | 5.2 | 19.1 | 53.0 | ● |

As can be seen from Table 7, with an Al₁O₃ content of 2 mol % or 8 mol %, which is outside the range 3.0 to 7.0 mol % shown in Tables 1 to 6, the judgment is “∘” even with Rf =1.

Combining the results shown in Tables 1 to 6 and Table 7, the Al₂O₃ content ratio is thus limited to being 3.0 to 7.0 mol %.

### Working Examples 35 to 64, and Comparative Examples 79 to 120

Here, the valid range for ZnO was studied. The sample manufacturing method was as in working example 1 described above, being carried out with the combinations shown in Tables 8 to 11. The judgment criteria were also as before. Note that here, Rf was fixed at 1, which is the central value for the present invention.

TABLE 8

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 113 | 70.8 | 9.0 | 3.0 | 7.1 | 4.2 | 0.7 | 12.0 | 5.0 | 0.1 | 0.0 | 0.1 | 0.0 | 0.2 | 1.0 | 655 | 3.0 | 9.8 | 8.0 | ● |
| 114 | 70.7 | 9.0 | 3.0 | 7.1 | 4.2 | 0.7 | 12.0 | 5.0 | 0.1 | 0.0 | 0.1 | 0.1 | 0.3 | 1.0 | 655 | 3.0 | 19.6 | 54.0 | ● |
| 115 | 69.8 | 9.0 | 3.0 | 7.1 | 4.2 | 0.7 | 12.0 | 6.0 | 0.1 | 0.0 | 0.1 | 0.0 | 0.2 | 1.0 | 640 | 3.5 | 9.7 | 7.0 | ◯ |
| 116 | 69.7 | 9.0 | 3.0 | 7.1 | 4.2 | 0.7 | 12.0 | 6.0 | 0.1 | 0.0 | 0.1 | 0.1 | 0.3 | 1.0 | 640 | 3.5 | 20.5 | 56.0 | ● |
| 117 | 65.8 | 9.0 | 3.0 | 7.1 | 4.2 | 0.7 | 12.0 | 10.0 | 0.1 | 0.0 | 0.1 | 0.0 | 0.2 | 1.0 | 610 | 3.6 | 9.9 | 9.0 | ◯ |
| 118 | 65.7 | 9.0 | 3.0 | 7.1 | 4.2 | 0.7 | 12.0 | 10.0 | 0.1 | 0.0 | 0.1 | 0.1 | 0.3 | 1.0 | 610 | 3.6 | 20.0 | 55.0 | ● |
| 119 | 61.8 | 9.0 | 3.0 | 7.1 | 4.2 | 0.7 | 12.0 | 14.0 | 0.1 | 0.0 | 0.1 | 0.0 | 0.2 | 1.0 | 600 | 3.7 | 9.7 | 7.0 | ◯ |
| 120 | 61.7 | 9.0 | 3.0 | 7.1 | 4.2 | 0.7 | 12.0 | 14.0 | 0.1 | 0.0 | 0.1 | 0.1 | 0.3 | 1.0 | 600 | 3.7 | 20.9 | 57.0 | ● |
| 121 | 57.8 | 9.0 | 3.0 | 7.1 | 4.2 | 0.7 | 12.0 | 18.0 | 0.1 | 0.0 | 0.1 | 0.0 | 0.2 | 1.0 | 595 | 4.6 | 9.8 | 8.0 | ◯ |
| 122 | 57.7 | 9.0 | 3.0 | 7.1 | 4.2 | 0.7 | 12.0 | 18.0 | 0.1 | 0.0 | 0.1 | 0.1 | 0.3 | 1.0 | 595 | 4.6 | 19.1 | 53.0 | ● |
| 123 | 56.8 | 9.0 | 3.0 | 7.1 | 4.2 | 0.7 | 12.0 | 19.0 | 0.1 | 0.0 | 0.1 | 0.0 | 0.2 | 1.0 | 590 | 5.3 | 9.9 | 9.0 | ● |
| 124 | 56.7 | 9.0 | 3.0 | 7.1 | 4.2 | 0.7 | 12.0 | 19.0 | 0.1 | 0.0 | 0.1 | 0.1 | 0.3 | 1.0 | 590 | 5.3 | 22.0 | 59.0 | ● |
| 125 | 62.8 | 9.0 | 7.0 | 9.4 | 5.6 | 0.9 | 16.0 | 5.0 | 0.1 | 0.0 | 0.1 | 0.0 | 0.2 | 1.0 | 655 | 1.6 | 9.8 | 8.0 | ● |
| 126 | 62.7 | 9.0 | 7.0 | 9.4 | 5.6 | 0.9 | 16.0 | 5.0 | 0.1 | 0.0 | 0.1 | 0.1 | 0.3 | 1.0 | 655 | 1.6 | 19.1 | 53.0 | ● |
| 127 | 61.8 | 9.0 | 7.0 | 9.4 | 5.6 | 0.9 | 16.0 | 6.0 | 0.1 | 0.0 | 0.1 | 0.0 | 0.2 | 1.0 | 645 | 2.1 | 9.7 | 7.0 | ◯ |
| 128 | 61.7 | 9.0 | 7.0 | 9.4 | 5.6 | 0.9 | 16.0 | 6.0 | 0.1 | 0.0 | 0.1 | 0.1 | 0.3 | 1.0 | 645 | 2.1 | 20.5 | 56.0 | ● |
| 129 | 57.8 | 9.0 | 7.0 | 9.4 | 5.6 | 0.9 | 16.0 | 10.0 | 0.1 | 0.0 | 0.1 | 0.0 | 0.2 | 1.0 | 615 | 2.2 | 9.9 | 9.0 | ◯ |
| 130 | 57.7 | 9.0 | 7.0 | 9.4 | 5.6 | 0.9 | 16.0 | 10.0 | 0.1 | 0.0 | 0.1 | 0.1 | 0.3 | 1.0 | 615 | 2.2 | 20.9 | 57.0 | ● |

TABLE 9

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 131 | 53.8 | 9.0 | 7.0 | 9.4 | 5.6 | 0.9 | 16.0 | 14.0 | 0.1 | 0.0 | 0.1 | 0.0 | 0.2 | 1.0 | 605 | 2.3 | 9.7 | 7.0 | ◯ |
| 132 | 53.7 | 9.0 | 7.0 | 9.4 | 5.6 | 0.9 | 16.0 | 14.0 | 0.1 | 0.0 | 0.1 | 0.1 | 0.3 | 1.0 | 605 | 2.3 | 22.0 | 59.0 | ● |
| 133 | 49.8 | 9.0 | 7.0 | 9.4 | 5.6 | 0.9 | 16.0 | 18.0 | 0.1 | 0.0 | 0.1 | 0.0 | 0.2 | 1.0 | 600 | 3.2 | 9.9 | 9.0 | ◯ |
| 134 | 49.7 | 9.0 | 7.0 | 9.4 | 5.6 | 0.9 | 16.0 | 18.0 | 0.1 | 0.0 | 0.1 | 0.1 | 0.3 | 1.0 | 600 | 3.2 | 23.1 | 61.0 | ● |
| 135 | 48.8 | 9.0 | 7.0 | 9.4 | 5.6 | 0.9 | 16.0 | 19.0 | 0.1 | 0.0 | 0.1 | 0.0 | 0.2 | 1.0 | 595 | 5.1 | 9.8 | 8.0 | ● |
| 136 | 48.7 | 9.0 | 7.0 | 9.4 | 5.6 | 0.9 | 16.0 | 19.0 | 0.1 | 0.0 | 0.1 | 0.1 | 0.3 | 1.0 | 595 | 5.1 | 21.4 | 58.0 | ● |
| 137 | 64.8 | 12.0 | 3.0 | 8.8 | 5.3 | 0.9 | 15.0 | 5.0 | 0.1 | 0.0 | 0.1 | 0.0 | 0.2 | 1.0 | 655 | 2.3 | 9.9 | 9.0 | ● |
| 138 | 64.7 | 12.0 | 3.0 | 8.8 | 5.3 | 0.9 | 15.0 | 5.0 | 0.1 | 0.0 | 0.1 | 0.1 | 0.3 | 1.0 | 655 | 2.3 | 20.0 | 55.0 | ● |
| 139 | 63.8 | 12.0 | 3.0 | 8.8 | 5.3 | 0.9 | 15.0 | 6.0 | 0.1 | 0.0 | 0.1 | 0.0 | 0.2 | 1.0 | 635 | 2.8 | 9.7 | 7.0 | ◯ |
| 140 | 63.7 | 12.0 | 3.0 | 8.8 | 5.3 | 0.9 | 15.0 | 6.0 | 0.1 | 0.0 | 0.1 | 0.1 | 0.3 | 1.0 | 635 | 2.8 | 19.1 | 53.0 | ● |
| 141 | 59.8 | 12.0 | 3.0 | 8.8 | 5.3 | 0.9 | 15.0 | 10.0 | 0.1 | 0.0 | 0.1 | 0.0 | 0.2 | 1.0 | 605 | 2.9 | 9.8 | 8.0 | ◯ |
| 142 | 59.7 | 12.0 | 3.0 | 8.8 | 5.3 | 0.9 | 15.0 | 10.0 | 0.1 | 0.0 | 0.1 | 0.1 | 0.3 | 1.0 | 605 | 2.9 | 21.4 | 58.0 | ● |
| 143 | 55.8 | 12.0 | 3.0 | 8.8 | 5.3 | 0.9 | 15.0 | 14.0 | 0.1 | 0.0 | 0.1 | 0.0 | 0.2 | 1.0 | 595 | 3.0 | 9.8 | 8.0 | ◯ |
| 144 | 55.7 | 12.0 | 3.0 | 8.8 | 5.3 | 0.9 | 15.0 | 14.0 | 0.1 | 0.0 | 0.1 | 0.1 | 0.3 | 1.0 | 595 | 3.0 | 23.1 | 61.0 | ● |
| 145 | 51.8 | 12.0 | 3.0 | 8.8 | 5.3 | 0.9 | 15.0 | 18.0 | 0.1 | 0.0 | 0.1 | 0.0 | 0.2 | 1.0 | 590 | 3.9 | 9.7 | 7.0 | ◯ |
| 146 | 51.7 | 12.0 | 3.0 | 8.8 | 5.3 | 0.9 | 15.0 | 18.0 | 0.1 | 0.0 | 0.1 | 0.1 | 0.3 | 1.0 | 590 | 3.9 | 20.5 | 56.0 | ● |
| 147 | 50.8 | 12.0 | 3.0 | 8.8 | 5.3 | 0.9 | 15.0 | 19.0 | 0.1 | 0.0 | 0.1 | 0.0 | 0.2 | 1.0 | 585 | 5.3 | 9.9 | 9.0 | ● |
| 148 | 50.7 | 12.0 | 3.0 | 8.8 | 5.3 | 0.9 | 15.0 | 19.0 | 0.1 | 0.0 | 0.1 | 0.1 | 0.3 | 1.0 | 585 | 5.3 | 20.9 | 57.0 | ● |

TABLE 10

| | | | | | | | | | | | | | | | | | Number | | |
|---|---|---|---|---|---|---|---|---|---|---|---|---|---|---|---|---|---|---|---|
| | | | | | | | | | | | | | | | | | of | SiO₂ | |
| | | | | | | | | | | | | | | | | Alkali | defects | Impu- | |
| | SiO₂ | B₂O₃ | Al₂O₃ | Li₂O | Na₂O | K₂O | ΣR₂O | ZnO | MgO | CaO | SrO | BaO | ΣMO | | | elution | (number | rity | |
| | mol | mol | mol | mol | mol | mol | mol | mol | mol | mol | mol | mol | mol | | Ts | amount | per | ratio | Judg- |
| No. | % | % | % | % | % | % | % | % | % | % | % | % | % | Rf | ° C. | (mg/m²) | surface) | (%) | ment |
| 149 | 56.8 | 12.0 | 7.0 | 11.2 | 6.7 | 1.1 | 19.0 | 5.0 | 0.1 | 0.0 | 0.1 | 0.0 | 0.2 | 1.0 | 655 | 1.3 | 9.8 | 8.0 | ● |
| 150 | 56.7 | 12.0 | 7.0 | 11.2 | 6.7 | 1.1 | 19.0 | 5.0 | 0.1 | 0.0 | 0.1 | 0.1 | 0.3 | 1.0 | 655 | 1.3 | 20.0 | 55.0 | ● |
| 151 | 55.8 | 12.0 | 7.0 | 11.2 | 6.7 | 1.1 | 19.0 | 6.0 | 0.1 | 0.0 | 0.1 | 0.0 | 0.2 | 1.0 | 645 | 1.8 | 9.8 | 8.0 | ◯ |
| 152 | 55.7 | 12.0 | 7.0 | 11.2 | 6.7 | 1.1 | 19.0 | 6.0 | 0.1 | 0.0 | 0.1 | 0.1 | 0.3 | 1.0 | 645 | 1.8 | 20.9 | 57.0 | ● |
| 153 | 51.8 | 12.0 | 7.0 | 11.2 | 6.7 | 1.1 | 19.0 | 10.0 | 0.1 | 0.0 | 0.1 | 0.0 | 0.2 | 1.0 | 615 | 1.9 | 9.9 | 9.0 | ◯ |
| 154 | 51.7 | 12.0 | 7.0 | 11.2 | 6.7 | 1.1 | 19.0 | 10.0 | 0.1 | 0.0 | 0.1 | 0.1 | 0.3 | 1.0 | 615 | 1.9 | 22.5 | 60.0 | ● |
| 155 | 47.8 | 12.0 | 7.0 | 11.2 | 6.7 | 1.1 | 19.0 | 14.0 | 0.1 | 0.0 | 0.1 | 0.0 | 0.2 | 1.0 | 605 | 2.0 | 9.7 | 7.0 | ◯ |
| 156 | 47.7 | 12.0 | 7.0 | 11.2 | 6.7 | 1.1 | 19.0 | 14.0 | 0.1 | 0.0 | 0.1 | 0.1 | 0.3 | 1.0 | 605 | 2.0 | 19.6 | 54.0 | ● |
| 157 | 43.8 | 12.0 | 7.0 | 11.2 | 67 | 1.1 | 19.0 | 18.0 | 0.1 | 0.0 | 0.1 | 0.0 | 0.2 | 1.0 | 600 | 2.9 | 9.8 | 8.0 | ◯ |
| 158 | 43.7 | 12.0 | 7.0 | 11.2 | 6.7 | 1.1 | 19.0 | 18.0 | 0.1 | 0.0 | 0.1 | 0.1 | 0.3 | 1.0 | 600 | 2.9 | 20.5 | 56.0 | ● |
| 159 | 43.8 | 12.0 | 7.0 | 11.2 | 6.7 | 1.1 | 19.0 | 18.0 | 0.1 | 0.0 | 0.1 | 0.0 | 0.2 | 1.0 | 595 | 5.1 | 9.9 | 9.0 | ● |
| 160 | 43.7 | 12.0 | 7.0 | 11.2 | 6.7 | 1.1 | 19.0 | 18.0 | 0.1 | 0.0 | 0.1 | 0.1 | 0.3 | 1.0 | 595 | 5.1 | 19.1 | 53.0 | ● |
| 161 | 60.8 | 14.0 | 3.0 | 10.0 | 6.0 | 1.0 | 17.0 | 5.0 | 0.1 | 0.0 | 0.1 | 0.0 | 0.2 | 1.0 | 655 | 2.2 | 9.7 | 7.0 | ● |
| 162 | 60.7 | 14.0 | 3.0 | 10.0 | 6.0 | 1.0 | 17.0 | 5.0 | 0.1 | 0.0 | 0.1 | 0.1 | 0.3 | 1.0 | 655 | 2.2 | 19.6 | 54.0 | ● |
| 163 | 59.8 | 14.0 | 3.0 | 10.0 | 6.0 | 1.0 | 17.0 | 6.0 | 0.1 | 0.0 | 0.1 | 0.0 | 0.2 | 1.0 | 635 | 2.7 | 9.9 | 9.0 | ◯ |
| 164 | 59.7 | 14.0 | 3.0 | 10.0 | 6.0 | 1.0 | 17.0 | 6.0 | 0.1 | 0.0 | 0.1 | 0.1 | 0.3 | 1.0 | 635 | 2.7 | 21.4 | 58.0 | ● |
| 165 | 55.8 | 14.0 | 3.0 | 10.0 | 6.0 | 1.0 | 17.0 | 10.0 | 0.1 | 0.0 | 0.1 | 0.0 | 0.2 | 1.0 | 605 | 2.8 | 9.8 | 8.0 | ◯ |
| 166 | 55.7 | 14.0 | 3.0 | 10.0 | 6.0 | 1.0 | 17.0 | 10.0 | 0.1 | 0.0 | 0.1 | 0.1 | 0.3 | 1.0 | 605 | 2.8 | 20.0 | 55.0 | ● |

TABLE 11

| | SiO₂ | B₂O₃ | Al₂O₃ | Li₂O | Na₂O | K₂O | ΣR₂O | ZnO | MgO | CaO |
|---|---|---|---|---|---|---|---|---|---|---|
| No. | mol % | mol % | mol % | mol % | mol % | mol % | mol % | mol % | mol % | mol % |
| 167 | 51.8 | 14.0 | 3.0 | 10.0 | 6.0 | 1.0 | 17.0 | 14.0 | 0.1 | 0.0 |
| 168 | 51.7 | 14.0 | 3.0 | 10.0 | 6.0 | 1.0 | 17.0 | 14.0 | 0.1 | 0.0 |
| 169 | 47.8 | 14.0 | 3.0 | 10.0 | 6.0 | 1.0 | 17.0 | 18.0 | 0.1 | 0.0 |
| 170 | 47.7 | 14.0 | 3.0 | 10.0 | 6.0 | 1.0 | 17.0 | 18.0 | 0.1 | 0.0 |
| 171 | 46.8 | 14.0 | 3.0 | 10.0 | 6.0 | 1.0 | 17.0 | 19.0 | 0.1 | 0.0 |
| 172 | 46.7 | 14.0 | 3.0 | 10.0 | 6.0 | 1.0 | 17.0 | 19.0 | 0.1 | 0.0 |
| 173 | 52.8 | 14.0 | 7.0 | 12.4 | 7.4 | 1.2 | 21.0 | 5.0 | 0.1 | 0.0 |
| 174 | 52.7 | 14.0 | 7.0 | 12.4 | 7.4 | 1.2 | 21.0 | 5.0 | 0.1 | 0.0 |
| 175 | 51.8 | 14.0 | 7.0 | 12.4 | 7.4 | 1.2 | 21.0 | 6.0 | 0.1 | 0.0 |
| 176 | 51.7 | 14.0 | 7.0 | 12.4 | 7.4 | 1.2 | 21.0 | 6.0 | 0.1 | 0.0 |
| 177 | 47.8 | 14.0 | 7.0 | 12.4 | 7.4 | 1.2 | 21.0 | 10.0 | 0.1 | 0.0 |
| 178 | 47.7 | 14.0 | 7.0 | 12.4 | 7.4 | 1.2 | 21.0 | 10.0 | 0.1 | 0.0 |
| 179 | 43.8 | 14.0 | 7.0 | 12.4 | 7.4 | 1.2 | 21.0 | 14.0 | 0.1 | 0.0 |
| 180 | 43.7 | 14.0 | 7.0 | 12.4 | 7.4 | 1.2 | 21.0 | 14.0 | 0.1 | 0.0 |
| 181 | 39.8 | 14.0 | 7.0 | 12.4 | 7.4 | 1.2 | 21.0 | 18.0 | 0.1 | 0.0 |
| 182 | 39.7 | 14.0 | 7.0 | 12.4 | 7.4 | 1.2 | 21.0 | 18.0 | 0.1 | 0.0 |
| 183 | 38.8 | 14.0 | 7.0 | 12.4 | 7.4 | 1.2 | 21.0 | 19.0 | 0.1 | 0.0 |
| 184 | 38.7 | 14.0 | 7.0 | 12.4 | 7.4 | 1.2 | 21.0 | 19.0 | 0.1 | 0.0 |

| | | | | | | | Number of | | |
|---|---|---|---|---|---|---|---|---|---|
| | | | | | | Alkali | defects | | |
| | | | | | | elution | (number | SiO₂ | |
| | SrO | BaO | ΣMO | | Ts | amount | per | impurity | |
| No. | mol % | mol % | mol % | Rf | ° C. | (mg/m²) | surface) | ratio (%) | Judgment |
| 167 | 0.1 | 0.0 | 0.2 | 1.0 | 595 | 2.9 | 9.7 | 7.0 | ◯ |
| 168 | 0.1 | 0.1 | 0.3 | 1.0 | 595 | 2.9 | 23.1 | 61.0 | ● |
| 169 | 0.1 | 0.0 | 0.2 | 1.0 | 590 | 3.8 | 9.7 | 7.0 | ◯ |
| 170 | 0.1 | 0.1 | 0.3 | 1.0 | 590 | 3.8 | 21.4 | 58.0 | ● |
| 171 | 0.1 | 0.0 | 0.2 | 1.0 | 584 | 5.2 | 9.9 | 9.0 | ● |
| 172 | 0.1 | 0.1 | 0.3 | 1.0 | 584 | 5.2 | 56.0 | 56.0 | ● |
| 173 | 0.1 | 0.0 | 0.2 | 1.0 | 655 | 1.7 | 9.9 | 9.0 | ● |
| 174 | 0.1 | 0.1 | 0.3 | 1.0 | 655 | 1.7 | 22.0 | 59.0 | ● |
| 175 | 0.1 | 0.0 | 0.2 | 1.0 | 640 | 2.2 | 9.7 | 7.0 | ◯ |
| 176 | 0.1 | 0.1 | 0.3 | 1.0 | 640 | 2.2 | 23.1 | 61.0 | ● |
| 177 | 0.1 | 0.0 | 0.2 | 1.0 | 610 | 2.3 | 9.8 | 8.0 | ◯ |
| 178 | 0.1 | 0.1 | 0.3 | 1.0 | 610 | 2.3 | 19.6 | 54.0 | ● |
| 179 | 0.1 | 0.0 | 0.2 | 1.0 | 600 | 2.4 | 9.8 | 8.0 | ◯ |
| 180 | 0.1 | 0.1 | 0.3 | 1.0 | 600 | 2.4 | 21.4 | 58.0 | ● |
| 181 | 0.1 | 0.0 | 0.2 | 1.0 | 595 | 3.4 | 9.9 | 9.0 | ◯ |
| 182 | 0.1 | 0.1 | 0.3 | 1.0 | 595 | 3.4 | 19.1 | 53.0 | ● |
| 183 | 0.1 | 0.0 | 0.2 | 1.0 | 590 | 5.3 | 9.7 | 7.0 | ● |
| 184 | 0.1 | 0.1 | 0.3 | 1.0 | 590 | 5.3 | 20.5 | 56.0 | ● |

As can be seen from nos. 123, 135, 147 and 159 (comparative examples 84, 91, 98 and 105) in Tables 8 to 11, if the ZnO content is more than 18.0 mol %, then the alkali elution amount becomes high, the judgment being “•”. The ZnO content is thus limited to being not more than 18.0 mol %. Moreover, if the ZnO content is less than 6.0 mol %, then Ts is more than 650° C., which is contrary to the present invention.

Moreover, although not shown here, in the case that an alkali metal having a large ionic radius such as K₂O, Rb₂O or Cs₂O is added, it is preferable to not add very much so that the chemical strengthening described earlier works effectively, the limit being approximately 1.5 mol %.

From the above, it can be seen that for an information recording medium substrate according to the present invention, suppression of alkali elution is excellent, and there are no streaked defects. Next, magnetic information recording media using an information recording medium substrate according to the present invention were studied.

### Working Example 65, and Comparative Examples 121 to 123

A Cr underlayer, a CoPtCr—SiO₂ granular magnetic layer, and a carbon protective film were formed in this order on both surfaces of each of the information recording medium substrates manufactured in no. 9 (working example 5), no.15 (comparative example 5), no. #1 and no. #2, thus manufacturing magnetic information recording media. To examine the weathering resistance of each magnetic information recording medium obtained, the magnetic information recording medium was left for 1000 hours in an 80° C. 85% RH environment, and substrate surface state and magnetic recording medium flying height tests were carried out. The results are shown in Table 12 as no. 185 (working example 65).

TABLE 12

| | SiO₂ | B₂O₃ | Al₂O₃ | Li₂O | Na₂O | K₂O | ΣR₂O | ZnO | MgO |
|---|---|---|---|---|---|---|---|---|---|
| No. | mol % | mol % | mol % | mol % | mol % | mol % | mol % | mol % | mol % |
| 185 | 53.8 | 12.0 | 5.0 | 10.0 | 6.0 | 1.0 | 17.0 | 12.0 | 0.1 |
| 186 | 53.7 | 12.0 | 5.0 | 10.0 | 6.0 | 1.0 | 17.0 | 12.0 | 0.1 |
| 187 | 58.0 | 14.0 | 7.0 | 12.4 | 7.4 | 1.2 | 21.0 | 0.0 | 0.0 |
| 188 | 66.0 | 2.0 | 7.0 | 14.7 | 8.8 | 1.5 | 25.0 | 0.0 | 0.0 |

| | CaO | SrO | BaO | ΣMO | | | Head flying |
|---|---|---|---|---|---|---|---|
| No. | mol % | mol % | mol % | mol % | Rf | Surface state | height (nm) |
| 185 | 0.1 | 0.0 | 0.0 | 0.2 | 1.0 | No surface defects | 5 |
| | | | | | | No change between | |
| | | | | | | before and test | |
| 186 | 0.1 | 0.1 | 0.0 | 0.3 | 1.0 | Are SiO2 surface defects | >10 |
| | | | | | | No change between | |
| | | | | | | before and after test | |
| 187 | 0.0 | 0.0 | 0.0 | 0.0 | 1.0 | Are streaky defects | >10 |
| | | | | | | No change between before | |
| | | | | | | and after test | |
| 188 | 0.0 | 0.0 | 0.0 | 0.0 | 9.0 | Li, Na precipitate out | >40 |

No. 185 has same compossition as no. 9, no. 186 as no. 15, no. 187 as #1, no. 186 as #2

As can be seen from Table 12, in the test results for no. 186 (comparative example 121) in which the amount of alkaline earth metals was greater than that stipulated in the present invention, the surface state did not change between before and after the test, but SiO₂ surface defects formed during the polishing were present, and hence the head flying height was greater than 10 nm. Moreover, in the test results for no. 187 (comparative example 122) in which ZnO was not contained, the surface state did not change between before and after the test, but there were surface defects caused by minute streaks, and hence the head flying height was greater than 10 nm. Moreover, in the test results for no. 188 (comparative example 123) in which the B₂O₃ content was less than the amount stipulated in the present invention, deposit having a dendritic structure of size several tens of μm comprising a mixed carbonate of lithium and sodium was seen on the surface. Reading/writing of recordings was thus impossible.

On the other hand, with the glass substrate of no. 185 (working example 65) manufactured in accordance with the present invention, precipitation of an alkali carbonate was not seen, and moreover no change in the flying height was seen. Moreover, the magnetic characteristics hardly changed from initially.

According to the present invention, an alkali ion-containing information recording medium glass substrate having little alkali elution and having no SiO₂ surface defects formed during polishing can be obtained, and by manufacturing an information recording medium using such a substrate, there can be provided a magnetic information recording medium that, even under a harsh weathering resistance test at 80° C. and 85% RH for 1000 hours, exhibits magnetic characteristics unchanged from initially.

As described above, according to the present invention, there can be provided an inexpensive information recording medium glass substrate having both good low-temperature workability and high weathering resistance, which are conflicting properties, a magnetic information recording medium using the information recording medium substrate, and methods of manufacturing the information recording medium substrate and the information recording medium.

While the present invention has been described in conjunction with embodiments and variations thereof, one of ordinary skill, after reviewing the foregoing specification, will be able to effect various changes, substitutions of equivalents and other alterations without departing from the broad concepts disclosed herein, It is therefore intended that Letters Patent granted hereon be limited only by the definition contained in the appended claims and equivalents thereof.

What is claimed is:

1. An information recording medium glass substrate, comprising:
a glass which has a glass composition including Si, Al, B, alkali metals (R), and Zn in molar proportions as oxides which satisfy (I) through (V) as follows:
0.8≦(R₂O content−Al₂O₃ content)/B₂O₃ content≦1.2, (I)
9.0 mol %≦B₂O₃ content≦14.0 mol %, (II)
3.0 mol %≦Al₂O₃ content≦7.0 mol %, (III)
6.0 mol %≦ZnO content≦18.0 mol %, and (IV)
40.0 mol %≦SiO₂ content. (V)

2. The information recording medium glass substrate according to claim 1, wherein the glass composition further satisfies (VI) as follows:
0≦MgO content+CaO content+SrO content+BaO content<0.3 mol %. (VI)

3. The information recording medium glass substrate according to claim 2, wherein the information recording medium glass substrate is molded.

4. The information recording medium glass substrate according to claim 2, wherein the information recording medium glass substrate is a perpendicular magnetic recording medium glass substrate.

5. The information recording medium glass substrate according to claim 1, wherein the information recording medium glass substrate is molded.

6. The information recording medium glass substrate according to claim 5, wherein the information recording medium glass substrate is a perpendicular magnetic recording medium glass substrate.

7. The information recording medium glass substrate according to claim 1, wherein the information recording medium glass substrate is a perpendicular magnetic recording medium glass substrate.

8. The information recording medium glass substrate according to claim 1, wherein the glass composition suppresses alkali elution from the glass substrate, and wherein the glass substrate has substantially no surface-attached foreign matter having a height of about 10 nm or less and having SiO₂ as a main component thereof.

9. An information recording medium, comprising:
a. an information recording medium glass substrate, comprising:
a glass which has a glass composition including Si, Al, B, alkali metals (R), and Zn in molar proportions as oxides which satisfy (I) through (V) as follows:
0.8≦(R₂O content−Al₂O₃ content)/B₂O₃ content≦1.2, (I)
9.0 mol %≦B₂O₃ content≦14.0 mol %, (II)
3.0 mol %≦Al₂O₃ content≦7.0 mol %, (III)
6.0 mol %≦ZnO content≦18.0 mol %, and (IV)
40.0 mol %≦SiO₂ content. (V)
b. a magnetic layer formed on the glass substrate.

10. The information recording medium according to claim 9, wherein the glass composition further satisfies (VI) as follows:
0≦MgO content+CaO content+SrO content+BaO content<0.3 mol %. (VI)

11. The information recording medium according to claim 10, wherein the information recording medium glass substrate is molded.

12. The information recording medium according to claim 10, wherein the information recording medium is a perpendicular magnetic recording medium.

13. The information recording medium according to claim 9, wherein the information recording medium glass substrate is molded.

14. The information recording medium according to claim 13, wherein the information recording medium is a perpendicular magnetic recording medium.

15. The information recording medium according to claim 9, wherein the information recording medium is a perpendicular magnetic recording medium.

16. The information recording medium according to claim 9, wherein the glass composition suppresses alkali elution from the glass substrate, and wherein the glass substrate has substantially no surface-attached foreign matter having a height of about 10 nm or less and having SiO₂ as a main component thereof.

17. The process of providing a glass substrate for an information recording medium, comprising:
a. formulating a glass having a glass composition including Si, Al, B, alkali metals (R), and Zn in molar proportions as oxides which satisfy (I) through (V) as follows:
0.8≦(R₂O content−Al₂O₃ content)/B₂O₃ content≦1.2, (I)
9.0 mol %≦B₂O₃ content≦14.0 mol %, (II)
3.0 mol %≦Al₂O₃ content≦7.0 mol %, (III)
6.0 mol %≦ZnO content≦18.0 mol %, and (IV)
40.0 mol %≦SiO₂ content. (V)
b. molding the glass composition to provide said glass substrate.

18. The process according to claim 17, wherein the glass composition further satisfies (VI) as follows:
0≦MgO content+CaO content+SrO content+BaO content<0.3 mol %. (VI)

19. The process according to claim 17, wherein the glass substrate is a perpendicular magnetic recording medium glass substrate.

20. The process according to claim 17, wherein the glass composition suppresses alkali elution from the glass substrate, and wherein the glass substrate has substantially no surface-attached foreign matter having a height of about 10 nm or less and having SiO₂ as a main component thereof.
